(19) United States
(12) Patent Application Publication
(10) Pub. No.: US 2018/0328197 A1
(43) Pub. Date: Nov. 15, 2018

(54) STATOR

(71) Applicant: EXEDY Corporation, Osaka (JP)

(72) Inventors: Yoshihiro KOJIMA, Osaka (JP); Masakatsu TOGAWA, Osaka (JP); Shigeo KAMIYA, Osaka (JP); Meiji YAMAUCHI, Osaka (JP)

(73) Assignee: EXEDY Corporation

(21) Appl. No.: 15/971,596

(22) Filed: May 4, 2018

(30) Foreign Application Priority Data
May 10, 2017 (JP) 2017-093839

(51) Int. Cl. F01D 9/04

(52) U.S. Cl. CPC F01D 9/041; F16H 41/26

(57) ABSTRACT

A stator includes a first stator member and a second stator member. The first stator member includes a plurality of first stator blades disposed at intervals in a circumferential direction. The second stator member includes a plurality of second stator blades disposed at intervals in the circumferential direction. The second stator member is fixed to the first stator member. The plurality of respective first stator blades and the plurality of respective second stator blades are aligned in the circumferential direction. At least a pair of the first and second stator blades disposed adjacently to each other in the circumferential direction partially overlaps as seen in an axial direction.

### CROSS-REFERENCE TO RELATED APPLICATIONS

This application claims priority to Japanese Patent Application No. 2017-093839 filed on May 10, 2017, the entirety of which is hereby incorporated by reference in its entirety.

### BACKGROUND

### Technical Field

The present disclosure relates to a stator for a torque converter.

### Background Information

A torque converter includes an impeller, a turbine and a stator (e.g., Japan Laid-open Patent Application Publication No. 2016-211716). The stator includes a plurality of stator blades aligned in a circumferential direction.

It is preferable to increase the number of stator blades in order to enhance performance of the torque converter. However, too much increase in number of stator blades results in a drawback of difficulty in molding. For example, when the stator is molded with a die, too much number of stator blades results in a drawback of difficulty in removal of the stator out of the die.

### BRIEF SUMMARY

It is an object of the present disclosure to provide a stator in which the number of stator blades can be increased than that in a well-known stator.

A stator according to an aspect of the present disclosure includes a first stator member and a second stator member. The first stator member includes a plurality of first stator blades disposed at intervals in a circumferential direction. The second stator member includes a plurality of second stator blades disposed at intervals in the circumferential direction. The second stator member is fixed to the first stator member. The plurality of respective first stator blades and the plurality of respective second stator blades are aligned in the circumferential direction. At least a pair of the first and second stator blades disposed adjacently to each other in the circumferential direction partially overlaps as seen in an axial direction.

According to this configuration, the first stator member includes the plurality of first stator blades, whereas the second stator member includes the plurality of second stator blades. Additionally, a single stator is produced by combining the first stator member and the second stator member. Therefore, even when each of the first and second stator members includes stator blades, the number of which is roughly equal to the number of stator blades in a well-known stator, the number of stator blades in the present stator as a whole can be increased than that in the well-known stator.

Preferably, the plurality of respective first stator blades and the plurality of respective second stator blades are alternately aligned in the circumferential direction.

Preferably, the first stator member further includes an outer tubular part extending in the axial direction. Additionally, each of the plurality of first stator blades extends inward from the outer tubular part in a radial direction.

Preferably, the outer tubular part includes a plurality of grooves on an inner peripheral surface thereof. Additionally, each of the plurality of second stator blades is disposed at a radially outer end portion thereof in each of the plurality of grooves. According to this configuration, with part of each stator blade being disposed in each groove of the outer tubular part, the second stator member can be positioned with respect to the first stator member.

Preferably, each of the plurality of second stator blades is joined at a radially outer end surface thereof to the inner peripheral surface of the outer tubular part.

Preferably, the first stator member further includes a first inner tubular part extending in the axial direction. Each of the plurality of first stator blades extends outward from the first inner tubular part in the radial direction.

Preferably, each of the plurality of second stator blades makes contact at part of a radially inner end surface thereof with an outer peripheral surface of the first inner tubular part. According to this configuration, the second stator member can be positioned with respect to the first stator member.

Preferably, the second stator member further includes a second inner tubular part disposed adjacently to the first inner tubular part in the axial direction. Each of the plurality of second stator blades extends outward from the second inner tubular part in the radial direction.

Preferably, each of the plurality of first stator blades makes contact at part of a radially inner end surface thereof with an outer peripheral surface of the second inner tubular part.

Preferably, the first inner tubular part includes a first step on a surface thereof disposed on a second inner tubular part side. Additionally, the second inner tubular part includes a second step, which is engaged with the first step in the circumferential direction, on a surface thereof disposed on a first inner tubular part side. According to this configuration, the first step and the second step are engaged with each other, whereby the first stator member and the second stator member can be inhibited from being disengaged from each other during rotation.

Preferably, the first inner tubular part is joined to the second inner tubular part.

Preferably, the first inner tubular part includes a smaller inner radius than the second inner tubular part.

Overall, according to the present disclosure, the number of stator blades can be increased than that in a well-known stator.

### BRIEF DESCRIPTION OF THE DRAWINGS

Referring now to the attached drawings which form a part of this original disclosure:

FIG. 1 is a front view of a stator;

FIG. 2 is a perspective view of the stator;

FIG. 3 is a perspective view of a first stator member;

FIG. 4 is a perspective view of a second stator member; and

FIG. 5 is a cross-sectional view of FIG. 1 taken along line V-V.

### DETAILED DESCRIPTION OF EMBODIMENTS

An exemplary embodiment of a stator according to the present disclosure will be hereinafter explained with reference to the attached drawings. It should be noted that in the following explanation, the term “axial direction” indicates an extending direction of a rotational axis O of the stator. On the other hand, the term “circumferential direction” indicates a circumferential direction of an imaginary circle about the rotational axis O, whereas the term “radial direction” indicates a radial direction of the imaginary circle about the rotational axis O. The term “radially outside” indicates a side separating from the rotational axis O in the radial direction, whereas the term “radially inside” indicates a side approaching to the rotational axis O in the radial direction.

### Stator

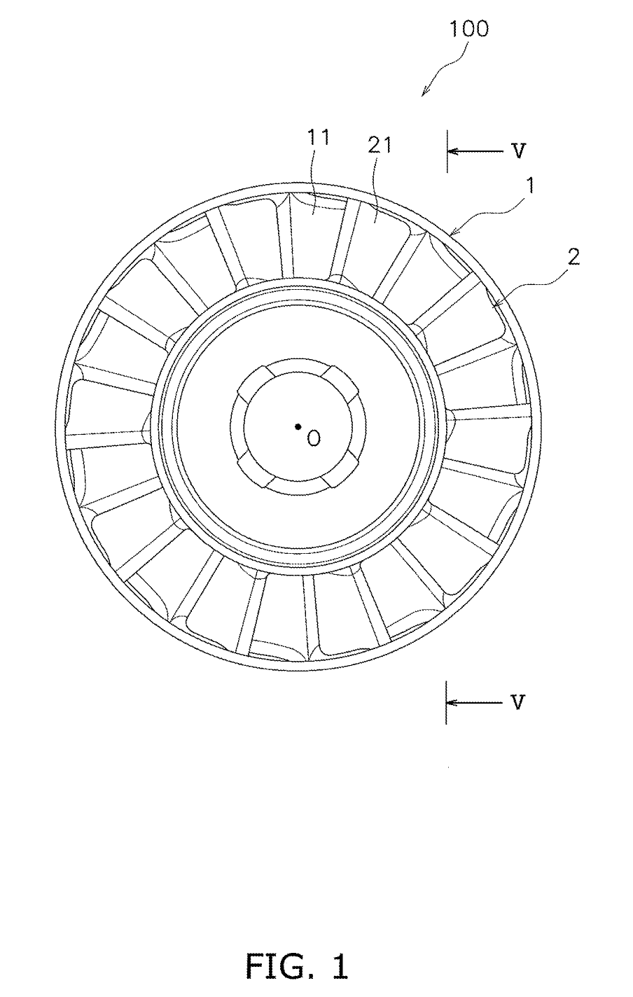

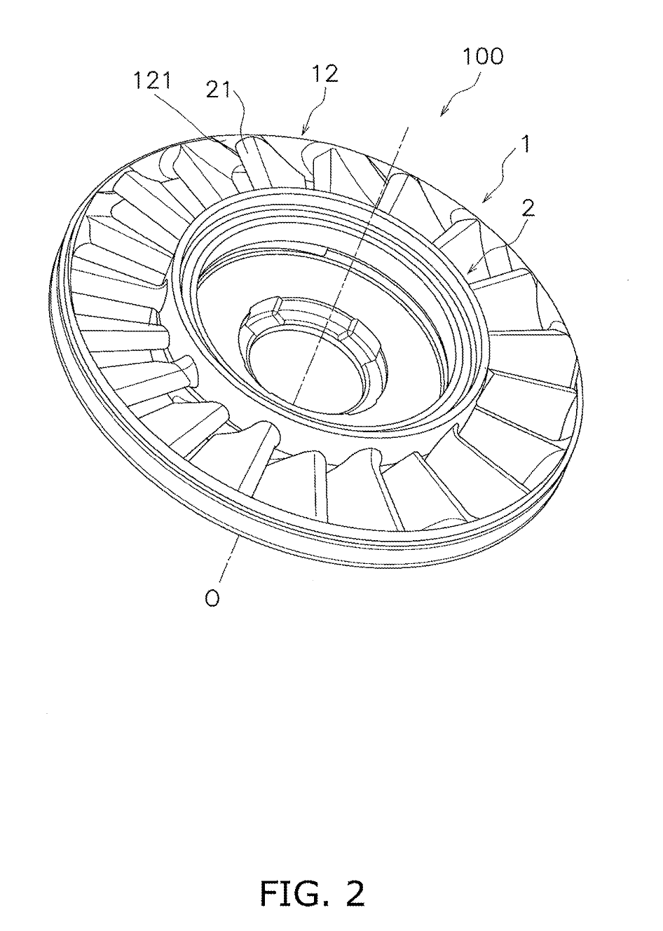

As shown in FIGS. 1 and 2, a stator 100 includes a first stator member 1 and a second stator member 2. The stator 100 is rotatable about the rotational axis O. The first stator member 1 and the second stator member 2 are fixed to each other, and are unitarily rotated. The first stator member 1 is disposed on a first side of the second stator member 2 in the axial direction, whereas the second stator member 2 is disposed on a second side of the first stator member 1 in the axial direction.

### First Stator Member

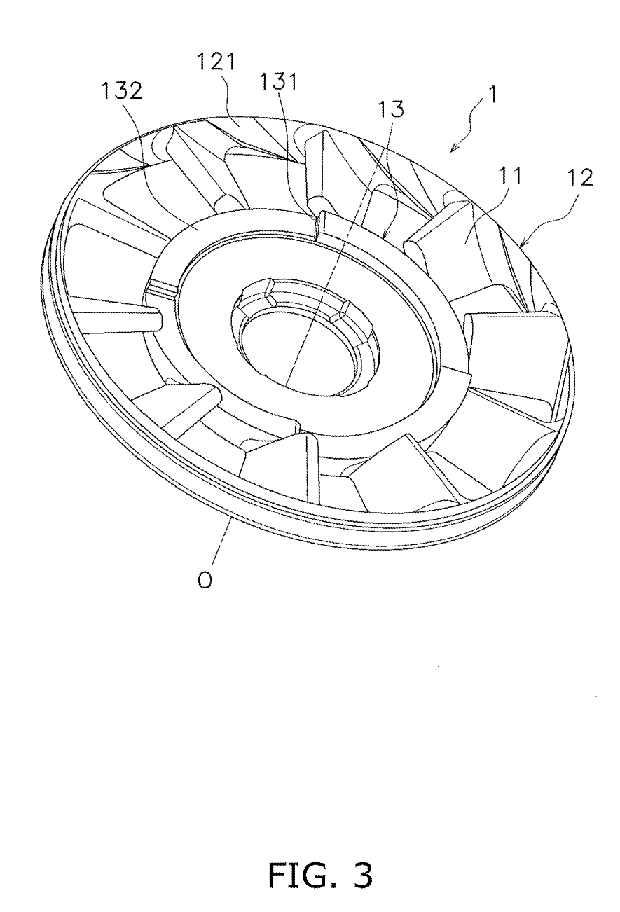

As shown in FIG. 3, the first stator member 1 includes a plurality of first stator blades 11, an outer tubular part 12 and a first inner tubular part 13. The respective first stator blades 11, the outer tubular part 12 and the first inner tubular part 13 are provided as a single member. For example, the first stator member 1 can be molded with a die by, for instance, casting, resin molding, compression molding or so forth.

First Stator Blades

The respective first stator blades 11 are disposed at intervals from each other in the circumferential direction.

Each first stator blade 11 extends in the radial direction. Detailedly, each first stator blade 11 extends between the outer tubular part 12 and the first inner tubular part 13 in the radial direction. Each first stator blade 11 has a plate shape and slants such that the principal surfaces thereof face not only in the axial direction but also in the circumferential direction. The thickness of each first stator blade 11 gradually reduces toward the first side in the axial direction.

The entirety of the radially outer end surface of each first stator blade 11 is disposed within the inner peripheral surface of the outer tubular part 12. On the other hand, part of the radially inner end surface of each first stator blade 11 protrudes from the outer peripheral surface of the first inner tubular part 13 to the second side in the axial direction. The part of the radially inner end surface of each first stator blade 11 makes contact with the outer peripheral surface of a second inner tubular part 22.

Outer Tubular Part

The outer tubular part 12 has a cylindrical shape and extends in the axial direction. The outer tubular part 12 includes a plurality of grooves 121 on the inner peripheral surface thereof. Each groove 121 is disposed between each pair of the first stator blades 11 located adjacently to each other in the circumferential direction. Each groove 121 slants to extend not only in the axial direction but also in the circumferential direction. The width of each groove 121 gradually reduces toward the first side in the axial direction.

First Inner Tubular Part

The first inner tubular part 13 is disposed radially inside the outer tubular part 12. The first inner tubular part 13 has a cylindrical shape and extends in the axial direction. The first inner tubular part 13 includes a plurality of first steps 131 on a surface thereof located on the second side in the axial direction. The respective first steps 131 are disposed at intervals in the circumferential direction. Preferably, the respective first steps 131 are disposed at equal intervals in the circumferential direction.

Detailedly, the first inner tubular part 13 includes a plurality of slopes 132 extending in the circumferential direction. Each slope 132 reduces in height along the circumferential direction. Each first step 131 is formed by a boundary region of each adjacent pair of the slopes 132.

### Second Stator Member

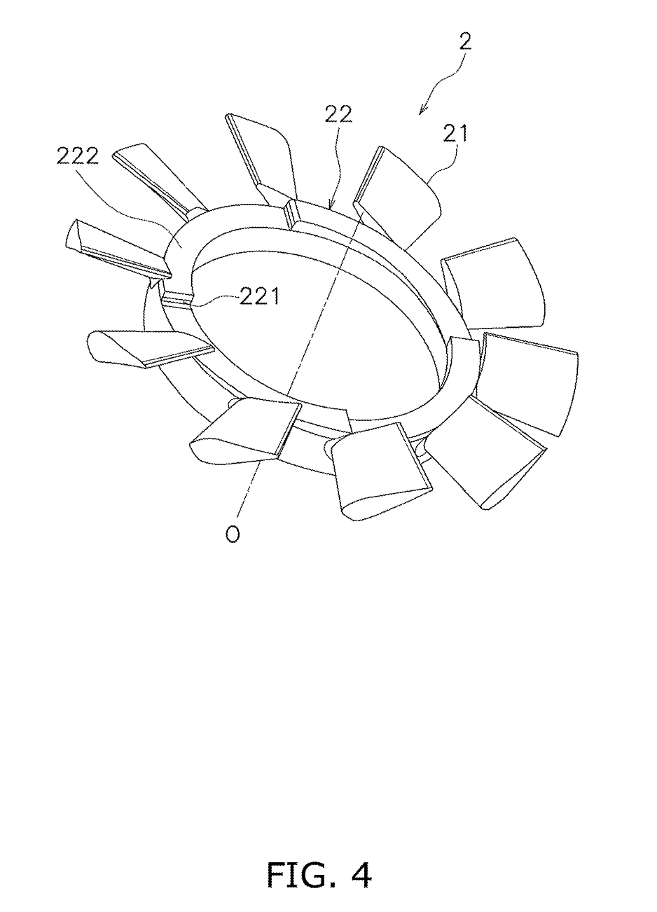

FIG. 4 is a perspective view of the second stator member 2 as seen from a side opposite to the side from which FIGS. 2 and 3 are seen. As shown in FIG. 4, the second stator member 2 includes a plurality of second stator blades 21 and the second inner tubular part 22. The respective second stator blades 21 and the second inner tubular part 22 are provided as a single member. For example, the second stator member 2 can be molded with a die by, for instance, casting, resin molding, compression molding or so forth. It should be noted that unlike the first stator member 1, the second stator member 2 does not include any outer tubular part.

Second Stator Blades

Each second stator blade 21 extends in the radial direction. Detailedly, each second stator blade 21 extends radially outward from the second inner tubular part 22. Each second stator blade 21 has substantially the same shape as each first stator blade 11 and also has substantially the same size as each first stator blade 11. Part of the radially inner end surface of each second stator blade 21 protrudes from the outer peripheral surface of the second inner tubular part 22 to the first side in the axial direction. Additionally, the part of the radially inner end surface of each second stator blade 21 makes contact with the outer peripheral surface of the first inner tubular part 13.

The respective second stator blades 21 are disposed at intervals from each other in the circumferential direction. As shown in FIGS. 1 and 2, the respective first stator blades 11 and the respective second stator blades 21 are aligned in the circumferential direction. Preferably, the respective first stator blades 11 and the respective second stator blades 21 are alternately aligned in the circumferential direction.

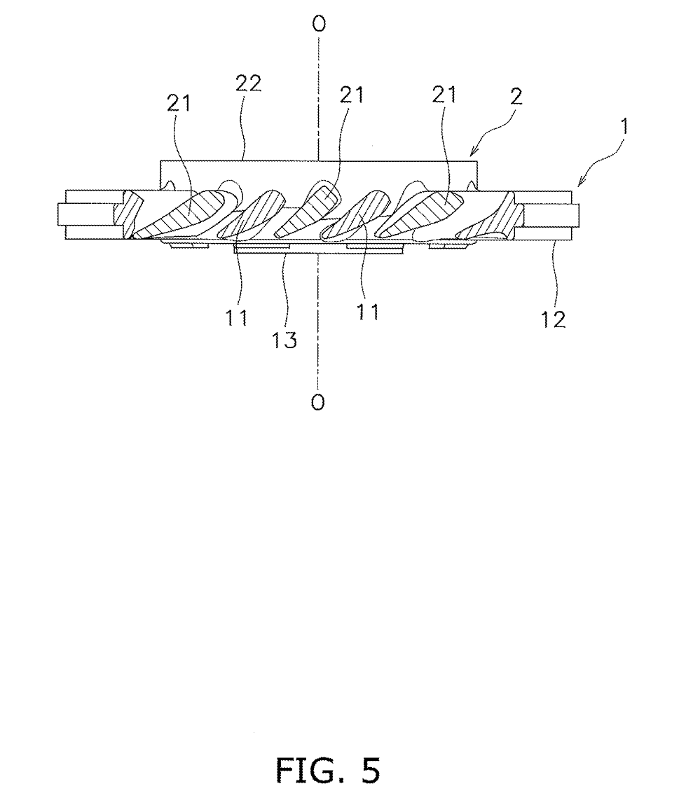

The circumferential length of each second stator blade 21 is longer than the interval between adjacent two of the first stator blades 11. Therefore, as shown in FIGS. 1 and 5, each pair of the first and second stator blades 11 and 21, disposed adjacently to each other in the circumferential direction, partially overlaps in an axial view. In other words, each adjacent pair of the first and second stator blades 11 and 21 overlaps at the adjacent circumferential end portions thereof in the axial view. Therefore, any interval is not produced between each adjacent pair of the first and second stator blades 11 and 21 in the axial view.

As shown in FIG. 2, the radially outer end portion of each second stator blade 21 is disposed within each groove 121 of the outer tubular part 12 of the first stator member 1. The first stator member 1 and the second stator member 2 are positioned to each other with the configuration that the radially outer end portion of each second stator blade 21 is disposed within each groove 121.

Second Inner Tubular Part

As shown in FIG. 4, the second inner tubular part 22 has a cylindrical shape and extends in the axial direction. The second inner tubular part 22 is disposed adjacently to the first inner tubular part 13 in the axial direction. The second inner tubular part 22 includes a plurality of second steps 221 on a surface thereof located on the first side in the axial direction. The respective second steps 221 are disposed in the circumferential direction at intervals equal to those at which the respective first steps 131 are disposed in the circumferential direction. Preferably, the respective second steps 221 are disposed at equal intervals. Each second step 221 is engaged with each first step 131 in the circumferential direction.

Detailedly, the second inner tubular part 22 includes a plurality of slopes 222 extending in the circumferential direction. Each slope 222 reduces in height along the circumferential direction. Each second step 221 is formed by a boundary region of each adjacent pair of the slopes 222.

The outer peripheral surface of the second inner tubular part 22 and that of the first inner tubular part 13 are substantially flush to each other. In other words, the outer diameter of the second inner tubular part 22 and that of the first inner tubular part 13 are substantially equal to each other. It should be noted that the inner diameter of the first inner tubular part 13 is less than that of the second inner tubular part 22.

The second stator member 2, configured as described above, is fixed to the first stator member 1, and hence, is unitarily rotated with the first stator member 1. Detailedly, the second stator member 2 is joined to the first stator member 1.

For example, the radially outer end surface of each second stator blade 21 and the inner peripheral surface of the outer tubular part 12 can be joined to each other. Additionally or alternatively, part of the radially inner end surface of each second stator blade 21 and the outer peripheral surface of the first inner tubular part 13 can be joined to each other, and or alternatively, part of the radially inner end surface of each first stator blade 11 and the outer peripheral surface of the second inner tubular part 22 can be joined to each other. Still additionally or alternatively, the first inner tubular part 13 and the second inner tubular part 22 can be joined to each other. It should be noted that a heretofore known method such as frictional press-contact can be employed as a joint method.

### Modifications

One exemplary embodiment of the present advancement has been described above. However, the present advancement is not limited to this, and a variety of changes can be made without departing from the gist of the present advancement.

For example, in the aforementioned exemplary embodiment, the first stator blades 11 and the second stator blades 21 are alternately aligned. However, alignment of the first and second stator blades 11 and 21 is not limited to this.

Additionally, in the aforementioned exemplary embodiment, each first stator blade 11 and each second stator blade 21 are configured to have substantially the same shape and the same size. However, the shape and size configuration of each first stator blade 11 and that of each second stator blade 21 are not particularly limited to this. In other words, each first stator blade 11 and each second stator blade 21 can have different shapes and different sizes.

What is claimed is:

1. A stator comprising:
a first stator member including a plurality of first stator blades disposed at intervals in a circumferential direction; and
a second stator member including a plurality of second stator blades disposed at intervals in the circumferential direction, the second stator member fixed to the first stator member, wherein
the plurality of respective first stator blades and the plurality of respective second stator blades are aligned in the circumferential direction, and
at least a pair of the first and second stator blades disposed adjacently to each other in the circumferential direction partially overlaps as seen in an axial direction.

2. The stator according to claim 1, wherein the plurality of respective first stator blades and the plurality of respective second stator blades are alternately aligned in the circumferential direction.

3. The stator according to claim 1, wherein
the first stator member further includes an outer tubular part extending in the axial direction, and
each of the plurality of first stator blades extends inward from the outer tubular part in a radial direction.

4. The stator according to claim 3, wherein
the outer tubular part includes a plurality of grooves on an inner peripheral surface thereof, and
each of the plurality of second stator blades is disposed at a radially outer end portion thereof in each of the plurality of grooves.

5. The stator according to claim 3, wherein each of the plurality of second stator blades is joined at a radially outer end surface thereof to an inner peripheral surface of the outer tubular part.

6. The stator according to claim 1, wherein
the first stator member further includes a first inner tubular part extending in the axial direction, and
each of the plurality of first stator blades extends outward from the first inner tubular part in a radial direction.

7. The stator according to claim 6, wherein each of the plurality of second stator blades makes contact at part of a radially inner end surface thereof with an outer peripheral surface of the first inner tubular part.

8. The stator according to claim 6, wherein
the second stator member further includes a second inner tubular part disposed adjacently to the first inner tubular part in the axial direction, and
each of the plurality of second stator blades extends outward from the second inner tubular part in the radial direction.

9. The stator according to claim 8, wherein each of the plurality of first stator blades makes contact at part of a radially inner end surface thereof with an outer peripheral surface of the second inner tubular part.

10. The stator according to claim 8, wherein
the first inner tubular part includes a first step on a surface thereof facing the second inner tubular part, and
the second inner tubular part includes a second step on a surface thereof facing the first inner tubular part, the second step engaged with the first step in the circumferential direction.

11. The stator according to claim 8, wherein the first inner tubular part is joined to the second inner tubular part.

12. The stator according to claim 8, wherein the first inner tubular part includes a smaller inner radius than the second inner tubular part.
